(19) United States
(12) Patent Application Publication
(10) Pub. No.: US 2019/0082443 A1
(43) Pub. Date: Mar. 14, 2019

(54) Communication of Persistent or Predictive Scheduling Information

(71) Applicant: Apple Inc., Cupertino, CA (US)

(72) Inventors: Guoqing Li, Cupertino, CA (US); Christiaan A. Hartman, San Jose, CA (US); Daniel R. Borges, San Francisco, CA (US); Jarkko L. Kneckt, Los Gatos, CA (US); Oren Shani, Saratoga, CA (US); Tushar R. Shah, Cupertino, CA (US); Xiaowen Wang, Cupertino, CA (US); Yong Liu, Campbell, CA (US); Christian W. Mucke, Cupertino, CA (US); Joseph Hakim, Soquel, CA (US); Farouk Belghoul, Campbell, CA (US); Ayman F. Naguib, Cupertino, CA (US); Karan Sanghi, San Jose, CA (US); Cahya Adiansyah Masputra, San Jose, CA (US)

(21) Appl. No.: 16/128,415

(22) Filed: Sep. 11, 2018

Related U.S. Application Data
(60) Provisional application No. 62/557,319, filed on Sep. 12, 2017.

(51) Int. Cl. H04W 72/12; H04W 28/02

(52) U.S. Cl. CPC H04W 72/12; H04W 84/12; H04W 28/0278

(57) ABSTRACT

An electronic device that determines a transmission schedule is described. This electronic device may include an interface circuit that communicates with a recipient electronic device. During operation, the electronic device may receive a frame with scheduling-request information that is associated with the recipient electronic device. The scheduling-request information may include a buffer status report for persistent traffic, and the frame may be compatible with an IEEE 802.11 communication protocol. For example, the frame may include a scheduling-request management frame. Alternatively, the frame may include a data frame and the scheduling-request information may be included in a media access control (MAC) frame header, such as a high-efficiency (HE) variant high-throughput (HT) control header. Then, the electronic device may determine the transmission schedule based at least in part on the scheduling-request information.

### CROSS-REFERENCE TO RELATED APPLICATION

This application claims the benefit of U.S. Provisional Application No. 62/557,319, entitled “Communication of Persistent or Predictive Scheduling Information,” by Guoqing Li, et al., filed Sep. 12, 2017, the contents of which are hereby incorporated by reference.

### FIELD

The described embodiments relate, generally, to wireless communications among electronic devices, and techniques for communicating persistent scheduling information and/or predictive scheduling information.

### BACKGROUND

Many electronic devices communicate with each other using wireless local area networks (WLANs), such as those based on a communication protocol that is compatible with an IEEE 802.11 standard (which is sometimes referred to as ‘Wi-Fi’). In existing Wi-Fi communication protocols, electronic devices access a shared communication channel using a contention-based protocol, such as enhanced distributed channel access (EDCA).

However, in crowded wireless environments, the use of a contention-based protocol may adversely affect the communication performance, such as the latency and/or throughput.

### SUMMARY

A first group of embodiments relates to an electronic device that receives a frame. This recipient electronic device may include a node that can be communicatively coupled to an antenna, and an interface circuit communicatively coupled to the node and that communicates with a recipient electronic device. During operation, the interface circuit receives the frame with scheduling-request information that is associated with the recipient electronic device, where the scheduling-request information includes a buffer status report for persistent traffic, and the frame is compatible with an IEEE 802.11 communication protocol.

Moreover, the frame may include a scheduling-request management frame.

Furthermore, the frame may include a data frame and the scheduling-request information may be included in a media access control (MAC) frame header. For example, the MAC frame header may include a high-efficiency (HE) variant high-throughput (HT) control header.

Additionally, the scheduling-request information may indicate whether the scheduling request is for scheduling initiation, scheduling modification or scheduling deletion. In some embodiments, the scheduling-request information may include: data-rate information, packet-size information, a packet interval, latency-requirement information, and/or a timeout value after which a scheduling-request is discarded. Moreover, the scheduling-request information may include: a persistent-traffic identifier and persistent-traffic information.

Note that the electronic device may determine a transmission schedule based at least in part on the scheduling-request information.

Moreover, the electronic device may provide an acknowledgement intended for the recipient electronic device in response to receiving the frame.

Furthermore, the electronic device may be an access point.

Other embodiments provide an interface circuit in the electronic device.

Other embodiments provide a computer-readable storage medium for use with the interface circuit in the electronic device. When program instructions stored in the computer-readable storage medium are executed by the interface circuit, the program instructions may cause the electronic device to perform at least some of the aforementioned operations of the electronic device.

Other embodiments provide a method for determining a transmission schedule. The method includes at least some of the aforementioned operations performed by the interface circuit in the electronic device.

A second group of embodiments relates to a recipient electronic device that provides a frame. This recipient electronic device may include a node that can be communicatively coupled to an antenna, and an interface circuit communicatively coupled to the node and that communicates with an electronic device. During operation, the interface circuit provides the frame with scheduling-request information intended for the electronic device, where the scheduling-request information comprises a buffer status report for persistent traffic, and the frame is compatible with an IEEE 802.11 communication protocol.

Moreover, the recipient electronic device may receive an acknowledgement associated with the electronic device in response to providing the frame.

Other embodiments provide an interface circuit in the recipient electronic device.

Other embodiments provide a computer-readable storage medium for use with the interface circuit in the recipient electronic device. When program instructions stored in the computer-readable storage medium are executed by the interface circuit, the program instructions may cause the recipient electronic device to perform at least some of the aforementioned operations of the recipient electronic device.

Other embodiments provide a method for providing a frame. The method includes at least some of the aforementioned operations performed by the interface circuit in the recipient electronic device.

A third group of embodiments relates to an electronic device that receives a frame. This electronic device may include a node that can be communicatively coupled to an antenna, and an interface circuit communicatively coupled to the node and that communicates with a recipient electronic device. During operation, the interface circuit receives the frame with scheduling-request information that is associated with the recipient electronic device, where the scheduling-request information includes a buffer status report for one or more predicted future queue sizes that are associated with traffic, and the frame is compatible with an IEEE 802.11 communication protocol.

Note that the electronic device may determine a transmission schedule based at least in part on the scheduling-request information.

Other embodiments provide an interface circuit in the electronic device.

Other embodiments provide a computer-readable storage medium for use with the interface circuit in the electronic device. When program instructions stored in the computer-readable storage medium are executed by the interface circuit, the program instructions may cause the electronic device to perform at least some of the aforementioned operations of the electronic device.

Other embodiments provide a method for determining a transmission schedule. The method includes at least some of the aforementioned operations performed by the interface circuit in the electronic device.

A fourth group of embodiments relates to a recipient electronic device that provides a frame. This recipient electronic device may include a node that can be communicatively coupled to an antenna, and an interface circuit communicatively coupled to the node and that communicates with an electronic device. During operation, the interface circuit provides the frame with scheduling-request information intended for the electronic device, where the scheduling-request information includes a buffer status report for one or more predicted future queue sizes that are associated with traffic, and the frame is compatible with an IEEE 802.11 communication protocol.

Moreover, the recipient electronic device may receive an acknowledgement associated with the electronic device in response to providing the frame.

Other embodiments provide an interface circuit in the recipient electronic device.

Other embodiments provide a computer-readable storage medium for use with the interface circuit in the recipient electronic device. When program instructions stored in the computer-readable storage medium are executed by the interface circuit, the program instructions may cause the recipient electronic device to perform at least some of the aforementioned operations of the recipient electronic device.

Other embodiments provide a method for providing a frame. The method includes at least some of the aforementioned operations performed by the interface circuit in the recipient electronic device.

This Summary is provided for purposes of illustrating some exemplary embodiments, so as to provide a basic understanding of some aspects of the subject matter described herein. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The included drawings are for illustrative purposes and serve only to provide examples of possible structures and arrangements for the disclosed systems and techniques for intelligently and efficiently managing communication between multiple associated user devices. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1 is a block diagram illustrating an example of electronic devices communicating wirelessly.

FIG. 2 is a flow diagram illustrating an example of a method for determining a transmission schedule using one of the electronic devices in FIG. 1.

FIG. 3 is a flow diagram illustrating an example of a method for providing a frame using one of the electronic devices in FIG. 1.

FIG. 4 is a flow diagram illustrating an example of communication between electronic devices, such as the electronic devices of FIG. 1.

FIGS. 5 and 6 are flow diagrams illustrating examples of communication between electronic devices, such as the electronic devices of FIG. 1.

FIG. 7 is a drawing illustrating an example of a management frame during communication between electronic devices, such as the electronic devices of FIG. 1.

FIG. 8 is a drawing illustrating an example of a media access control (MAC) frame header during communication between electronic devices, such as the electronic devices of FIG. 1.

FIG. 9 is a drawing illustrating an example of a frame header during communication between electronic devices, such as the electronic devices of FIG. 1.

FIG. 10 is a block diagram illustrating an example of one of the electronic devices of FIG. 1.

Table 1 includes examples of persistent-traffic schedule requests and persistent traffic information.

Note that like reference numerals refer to corresponding parts throughout the drawings. Moreover, multiple instances of the same part are designated by a common prefix separated from an instance number by a dash.

### DETAILED DESCRIPTION

An electronic device that determines a transmission schedule is described. This electronic device may include an interface circuit that communicates with a recipient electronic device. During operation, the electronic device may receive a frame with scheduling-request information that is associated with the recipient electronic device. The scheduling-request information may include a buffer status report for persistent traffic, and the frame may be compatible with an IEEE 802.11 communication protocol. For example, the frame may include a scheduling-request management frame. Alternatively, the frame may include a data frame and the scheduling-request information may be included in a media access control (MAC) frame header, such as a high-efficiency (HE) variant high-throughput (HT) control header. Then, the electronic device may determine the transmission schedule based at least in part on the scheduling-request information.

By communicating the buffer status report, this communication technique may allow the electronic device to determine the transmission schedule using accurate information that is communicated in a regular and timely manner. Therefore, the communication technique may facilitate a schedule-based protocol for channel access. For example, the electronic device may trigger the recipient electronic device based at least in part on the determined transmission schedule, which may eliminate contention for a communication medium. Moreover, the communication technique may allow the electronic device to dynamically adapt the transmission schedule based at least in part on changing conditions. Consequently, the communication technique may improve the communication performance between the electronic device and the recipient electronic device, such as increased throughput and/or decreased latency. Therefore, the communication technique may improve the user experience when using the electronic device or the recipient electronic device, and therefore may increase customer satisfaction and retention.

Note that the communication technique may be used during wireless communication between electronic devices in accordance with a communication protocol, such as a communication protocol that is compatible with an IEEE 802.11 standard (which is sometimes referred to as Wi-Fi). In some embodiments, the communication technique is used with IEEE 802.11BA and/or IEEE 802.11ax, which are used as illustrative examples in the discussion that follows. However, this communication technique may also be used with a wide variety of other communication protocols, and in electronic devices (such as portable electronic devices or mobile devices) that can incorporate multiple different radio access technologies (RATs) to provide connections through different wireless networks that offer different services and/or capabilities.

An electronic device can include hardware and software to support a wireless personal area network (WPAN) according to a WPAN communication protocol, such as those standardized by the Bluetooth Special Interest Group (in Kirkland, Wash.) and/or those developed by Apple (in Cupertino, Calif.) that are referred to as an Apple Wireless Direct Link (AWDL). Moreover, the electronic device can communicate via: a wireless wide area network (WWAN), a wireless metro area network (WMAN), a WLAN, near-field communication (NFC), a cellular-telephone or data network (such as using a third generation (3G) communication protocol, a fourth generation (4G) communication protocol, e.g., Long Term Evolution or LTE, LTE Advanced (LTE-A), a fifth generation (5G) communication protocol, or other present or future developed advanced cellular communication protocol) and/or another communication protocol. In some embodiments, the communication protocol includes a peer-to-peer communication technique.

The electronic device, in some embodiments, can also operate as part of a wireless communication system, which can include a set of client devices, which can also be referred to as stations or client electronic devices, interconnected to an access point, e.g., as part of a WLAN, and/or to each other, e.g., as part of a WPAN and/or an ‘ad hoc’ wireless network, such as a Wi-Fi direct connection. In some embodiments, the client device can be any electronic device that is capable of communicating via a WLAN technology, e.g., in accordance with a WLAN communication protocol. Furthermore, in some embodiments, the WLAN technology can include a Wi-Fi (or more generically a WLAN) wireless communication subsystem or radio, and the Wi-Fi radio can implement an IEEE 802.11 technology, such as one or more of: IEEE 802.11a; IEEE 802.1lb; IEEE 802.11g; IEEE 802.11-2007; IEEE 802.11n; IEEE 802.11-2012; IEEE 802.11ac; IEEE 802.11ax, or other present or future developed IEEE 802.11 technologies.

In some embodiments, the electronic device can act as a communications hub that provides access to a WLAN and/or to a WWAN and, thus, to a wide variety of services that can be supported by various applications executing on the electronic device. Thus, the electronic device may include an ‘access point’ that communicates wirelessly with other electronic devices (such as using Wi-Fi), and that provides access to another network (such as the Internet) via IEEE 802.3 (which is sometimes referred to as ‘Ethernet’). However, in other embodiments the electronic device may not be an access point. As an illustrative example, in the discussion that follows the electronic device is or includes an access point.

Additionally, it should be understood that the electronic devices described herein may be configured as multi-mode wireless communication devices that are also capable of communicating via different 3G and/or second generation (2G) RATs. In these scenarios, a multi-mode electronic device or UE can be configured to prefer attachment to LTE networks offering faster data rate throughput, as compared to other 3G legacy networks offering lower data rate throughputs. For example, in some implementations, a multi-mode electronic device is configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable.

In accordance with various embodiments described herein, the terms ‘wireless communication device,’ ‘electronic device,’ ‘mobile device,’ ‘mobile station,’ ‘wireless station,’ ‘wireless access point,’ ‘station,’ ‘access point’ and ‘user equipment’ (UE) may be used herein to describe one or more consumer electronic devices that may be capable of performing procedures associated with various embodiments of the disclosure.

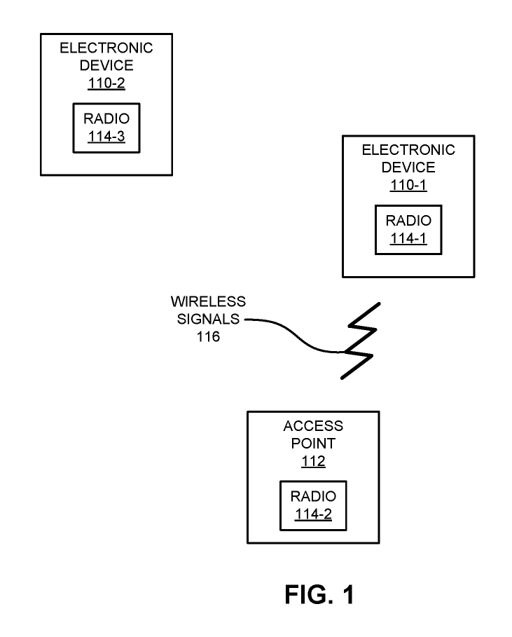

FIG. 1 presents a block diagram illustrating an example of electronic devices communicating wirelessly. Notably, one or more electronic devices 110 (such as a smartphone, a laptop computer, a notebook computer, a tablet, or another such electronic device) and access point 112 may communicate wirelessly in a WLAN using an IEEE 802.11 communication protocol. Thus, electronic devices 110 may be associated with access point 112. For example, electronic devices 110 and access point 112 may wirelessly communicate while: detecting one another by scanning wireless channels, transmitting and receiving beacons or beacon frames on wireless channels, establishing connections (for example, by transmitting connect requests), and/or transmitting and receiving packets or frames (which may include the request and/or additional information, such as data, as payloads). Note that access point 112 may provide access to a network, such as the Internet, via an Ethernet protocol, and may be a physical access point or a virtual or ‘software’ access point that is implemented on a computer or an electronic device. In the discussion that follows, electronic devices 110 are sometimes referred to as ‘recipient electronic devices.’

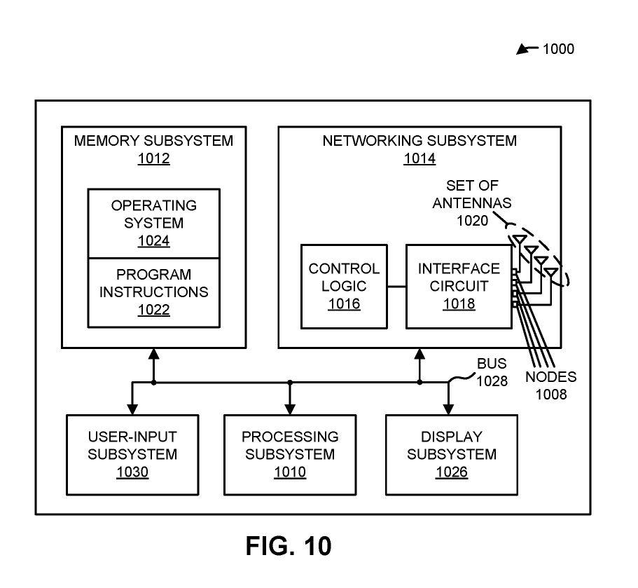

As described further below with reference to FIG. 10, electronic devices 110 and access point 112 may include subsystems, such as a networking subsystem, a memory subsystem, and a processor subsystem. In addition, electronic devices 110 and access point 112 may include radios 114 in the networking subsystems. More generally, electronic devices 110 and access point 112 can include (or can be included within) any electronic devices with networking subsystems that enable electronic devices 110 and access point 112, respectively, to wirelessly communicate with another electronic device. This can include transmitting beacons on wireless channels to enable the electronic devices to make initial contact with or to detect each other, followed by exchanging subsequent data/management frames (such as connect requests) to establish a connection, configure security options (e.g., IPSec), transmit and receive packets or frames via the connection, etc.

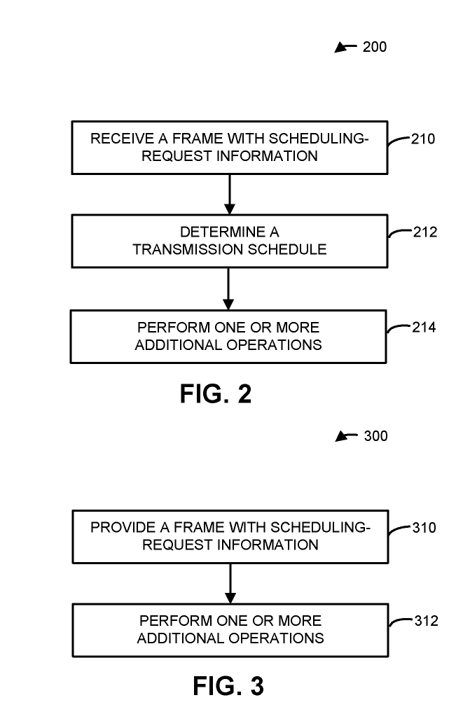

As can be seen in FIG. 1, wireless signals 116 (represented by a jagged line) are communicated by radios 114-1 and 114-2 in electronic device 110-1 and access point 112, respectively. For example, as noted previously, electronic device 110-1 and access point 112 may exchange packets using a Wi-Fi communication protocol in a WLAN. As illustrated further below with reference to FIGS. 2-4, radio 114-1 may receive wireless signals 116 that are transmitted by radio 114-2. Alternatively, radio 114-1 may transmit wireless signals 116 that are received by radio 114-2.

As discussed previously, in many Wi-Fi communication protocols, electronic devices 110 and access point 112 access a shared communication channel or medium using a contention-based protocol, such as EDCA. However, in crowded wireless environments, this approach may adversely affect the communication performance, such as the latency and/or throughput.

In order to eliminate contention for the communication medium, a schedule-based protocol has been proposed for use in IEEE802.11ax. This approach may improve the communication performance. For example, electronic devices 110 may report their current buffer or queue status to access point 112, which can use this information in determining a transmission schedule. Then, access point 112 may communicate (such as by providing a trigger frame) to one or more electronic devices 110 based at least in part on the transmission schedule, thereby eliminating contention by the electronic devices 110 for the shared communication medium.

Moreover, in order to implement the schedule-based protocol, access point 112 may need to receive information specifying the current buffer status from electronic devices 110 in a regular and a timely manner. When there are delays in receiving this information, the transmission schedule determined by access point 112 may be inaccurate. In addition, because the transmission schedule is based on the current buffer status, it can be difficult for access point 112 to adapt to changing conditions.

In order to address these problems, electronic device 110-1 may provide a frame (or packet) with scheduling-request information to access point 112. In some embodiments, the scheduling-request information includes a buffer status report for persistent traffic, and the frame is compatible with an IEEE802.11 communication protocol. Alternatively or additionally, the scheduling-request information may include a buffer status report for one or more predicted future queue sizes that are associated with traffic, and the frame may be compatible with the IEEE802.11 communication protocol.

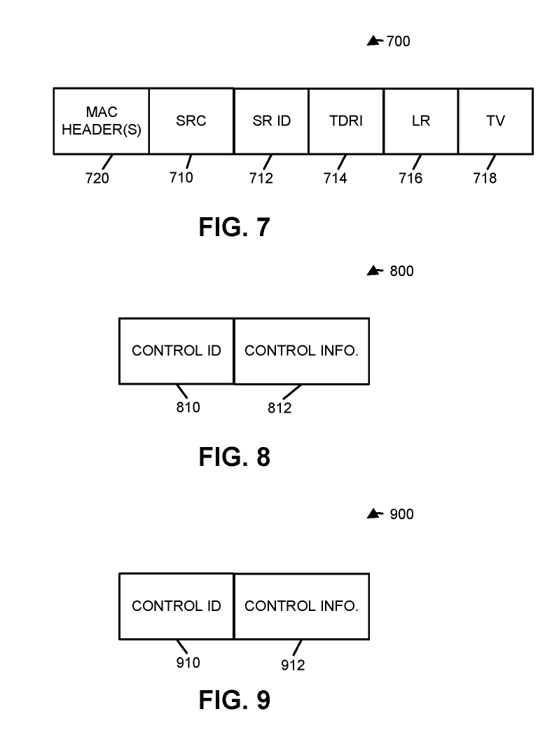

For example, as described further below with reference to FIG. 7, the frame may include a scheduling-request management frame. Alternatively, as described further below with reference to FIGS. 8 and 9, the frame may include a data frame and the scheduling-request information may be included in a MAC frame header, such as a HE variant HT control header.

Moreover, the scheduling-request information may indicate whether the scheduling request is for scheduling initiation, scheduling modification or scheduling deletion. In some embodiments, the scheduling-request information may include: data-rate information, packet-size information, a packet interval, latency-requirement information, and/or a timeout value after which a scheduling-request is discarded. Furthermore, the scheduling-request information may include: a persistent-traffic identifier and persistent-traffic information.

In response to receiving the scheduling-request information, access point 112 may determine a transmission schedule based at least in part on the scheduling-request information. Subsequently, when access point 112 receives data (and, more generally, traffic intended for electronic device 110-1), access point 112 may communicate the data (or traffic) with electronic device 110-1 based at least in part on the determined transmission schedule. For example, access point 112 may use the determined transmission schedule in a schedule-based protocol for channel access. Similarly, access point 112 may assign a communication medium to electronic device 110-1 for uplink traffic or communication based at least in part on the determined transmission schedule.

In these ways, the communication technique may allow electronic devices 110 and access point 112 to dynamically determine an accurate transmission schedule and, thus, to communicate efficiently (such as with improved throughput and/or reduced latency). These capabilities may improve the user experience when using electronic devices 110.

Note that access point 112 and at least some of electronic devices 110 may be compatible with an IEEE802.11 standard that includes trigger-based channel access (such as IEEE802.11ax). However, access point 112 and at least this subset of electronic devices 110 may also communicate with one or more legacy electronic devices that are not compatible with the IEEE802.11 standard (i.e., that do not use multi-user trigger-based channel access). In some embodiments, at least a subset of electronic devices 110 use multi-user transmission (such as orthogonal frequency division multiple access or OFDMA). For example, radio 114-2 may provide a trigger frame for the subset of recipient electronic devices. Moreover, in response to receiving the trigger frame, radio 114-1 may provide a group acknowledgment to radio 114-2. For example, radio 114-1 may provide the acknowledgment during an assigned time slot and/or in an assigned channel in the group acknowledgment. However, in some embodiments the one or more of electronic devices 110 may individually provide acknowledgments to radio 114-2. Thus, radio 114-1 (and, more generally, radios 114 in the one or more electronic devices 110) may provide an acknowledgment to radio 114-2.

In the described embodiments, processing a packet or frame in one of electronic devices 110 and access point 112 includes: receiving wireless signals 116 encoding a packet or a frame; decoding/extracting the packet or frame from received wireless signals 116 to acquire the packet or frame; and processing the packet or frame to determine information contained in the packet or frame (such as data in the payload).

In general, the communication via the WLAN in the communication technique may be characterized by a variety of communication-performance metrics. For example, the communication-performance metric may include any/all of: an RSSI, a data rate, a data rate for successful communication (which is sometimes referred to as a ‘throughput’), a latency, an error rate (such as a retry or resend rate), a mean-square error of equalized signals relative to an equalization target, inter-symbol interference, multipath interference, a signal-to-noise ratio (SNR), a width of an eye pattern, a ratio of a number of bytes successfully communicated during a time interval (such as a time interval between, e.g., 1 and 10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’).

Although we describe the network environment shown in FIG. 1 as an example, in alternative embodiments, different numbers and/or types of electronic devices may be present. For example, some embodiments may include more or fewer electronic devices. As another example, in other embodiments, different electronic devices can be transmitting and/or receiving packets or frames.

FIG. 2 presents a flow diagram illustrating an example method 200 for determining a transmission schedule. This method may be performed by an electronic device, such as access point 112 in FIG. 1. During operation, the electronic device may receive a frame with scheduling-request information (operation 210) that is associated with the recipient electronic device. In some embodiments, the scheduling-request information includes a buffer status report for persistent traffic, and the frame is compatible with an IEEE802.11 communication protocol. Alternatively or additionally, the scheduling-request information may include a buffer status report for one or more predicted future queue sizes that are associated with traffic, and the frame may be compatible with the IEEE802.11 communication protocol.

For example, the frame may include a scheduling-request management frame. Alternatively, the frame may include a data frame and the scheduling-request information may be included in a MAC frame header, such as a HE variant HT control header.

Moreover, the scheduling-request information may indicate whether the scheduling request is for scheduling initiation, scheduling modification or scheduling deletion. In some embodiments, the scheduling-request information may include: data-rate information, packet-size information, a packet interval, latency-requirement information, and/or a timeout value after which a scheduling-request is discarded. Furthermore, the scheduling-request information may include: a persistent-traffic identifier and persistent-traffic information.

Then, the electronic device may optionally determine a transmission schedule (operation 212) based at least in part on the scheduling-request information.

In some embodiments, the electronic device optionally performs one or more additional operations (operation 214). For example, the electronic device may provide an acknowledgement intended for the recipient electronic device in response to receiving the frame. Moreover, the electronic device may provide information that specifies the determined transmission schedule, which is intended for the recipient electronic device.

FIG. 3 presents a flow diagram illustrating an example method 300 for providing a frame. This method may be performed by a recipient electronic device, such as electronic device 110-1 in FIG. 1. During operation, the recipient electronic device may provide a frame with scheduling-request information (operation 310) that is intended for an electronic device. In some embodiments, the scheduling-request information includes a buffer status report for persistent traffic, and the frame is compatible with an IEEE802.11 communication protocol. Alternatively or additionally, the scheduling-request information may include a buffer status report for one or more predicted future queue sizes that are associated with traffic, and the frame may be compatible with the IEEE802.11 communication protocol.

In some embodiments, the recipient electronic device optionally performs one or more additional operations (operation 312). For example, the recipient electronic device may receive an acknowledgement associated with the electronic device in response to providing the frame. Alternatively or additionally, the recipient electronic device may receive information that specifies a determined transmission schedule, which is associated with the electronic device.

In some embodiments of methods 200 (FIG. 2) and/or 300, there may be additional or fewer operations. Moreover, the order of the operations may be changed, and/or two or more operations may be combined into a single operation or performed at least partially in parallel.

In some embodiments, at least some of the operations in methods 200 (FIG. 2) and/or 300 are, at least in part, performed by an interface circuit in the electronic device. For example, at least some of the operations may be performed by firmware executed by an interface circuit, such as firmware associated with a MAC layer, as well as one or more circuits in a physical layer in the interface circuit.

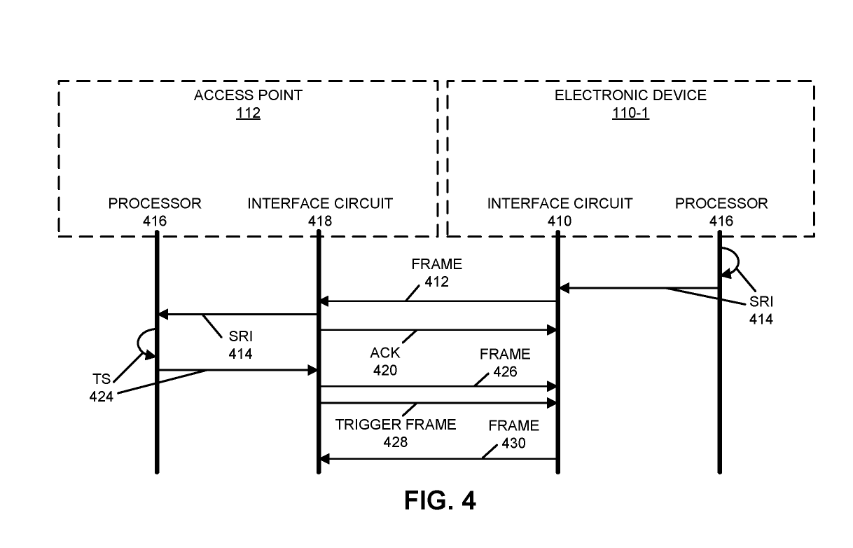

The communication technique is further illustrated in FIG. 4, which presents a flow diagram illustrating an example of communication between electronic device 110-1 and access point 112. After associating with access point 112, interface circuit 410 in electronic device 110-1 may provide a frame 412 (which is compatible with an IEEE802.11 communication protocol) to access point 112 with scheduling-request information (SRI) 414. For example, processor 416 in electronic device may determine and provide scheduling-request information 414 to interface circuit 410. In some embodiments, scheduling-request information 414 includes a buffer status report for persistent traffic and/or a buffer status report for one or more predicted future queue sizes that are associated with traffic.

After receiving frame 412, interface circuit 418 in access point 112 may optionally provide an acknowledgement (ACK) 420 to electronic device 110-1. Moreover, processor 422 in access point 112 may optionally determine a transmission schedule (TS) 424 for electronic device 110-1 based at least in part on scheduling-request information 414. In some embodiments, interface circuit may optionally provide a frame 426 (or packet) with information that specifies the determined transmission schedule 424 to electronic device 110-1.

Subsequently, such as when there is traffic to or from electronic device 110-1, and based at least in part on transmission schedule 424, access point 112 may communicate with electronic device 110-1. For example, interface circuit 418 may provide a trigger frame 428 to electronic device 110-1. In response to receiving trigger frame 428, interface circuit 410 may transmit a frame 430 to access point 112.

While communication between the components in FIG. 4 is illustrated with unilateral or bilateral communication (e.g., lines having a single arrow or dual arrows), in general a given communication operation may be unilateral or bilateral.

In some embodiments, the communication technique is used to facilitate a schedule-based protocol. Notably, IEEE802.11axis the first 802.11 standard that defines downlink/uplink (DL/UL) OFDMA and UL multi-user (MU) multiple-input multiple output (MIMO). These capabilities can enable Wi-Fi to transition into a schedule-based channel-access protocol. In a highly congested wireless environment, centralized scheduling often provides better communication performance than distributed contention-based operation. However, in order to properly use UL MU operation, a scheduling technique used by an access point should have accurate information about the UL traffic status of an electronic device or a station (STA), which is other than an access point, and which is sometimes referred to as a ‘recipient electronic device’. Consequently, the IEEE802.11ax specification defines various types of buffer status reports (BSRs). For example, a BSR may be included in a HE control field in a MAC header in a frame. Alternatively, a BSR may be included in a quality-of-service (QoS) control field. Other approaches (such as a different field) for communicating a BSR may be implemented or used.

Morever, typically an electronic device can only report current queue sizes in a BSR, and thus an access point may not be able to allocate resources for an electronic device for potential near-term future traffic. Furthermore, there may be a long delay until an electronic device sends out a BSR. For example, an electronic device may send a BSR in an UL MU physical layer convergence procedure (PLCP) protocol data unit (PPDU) that is scheduled by an access point, or in a single-user (SU) PPDU that is sent by an electronic device through contention (such as using EDCA). However, because an IEEE802.11ax-compatible access point may lower the contention priority of an electronic device when the electronic device starts to participate in an UL MU transmission, there may be long delays between when a BSR is generated and when the BSR is sent using contention-based access. Alternatively, if a BSR is sent using a UL MU PPDU, there is no guarantee than an access point will schedule an electronic device to transmit the BSR in a timely manner, e.g., because the access point does not have information about the traffic characteristics of the electronic device. Consequently, the BSR of an electronic device may not be delivered to the access point in a timely manner and, therefore, the resources provided by the access point may not satisfy one or more QoS requirements of the electronic device.

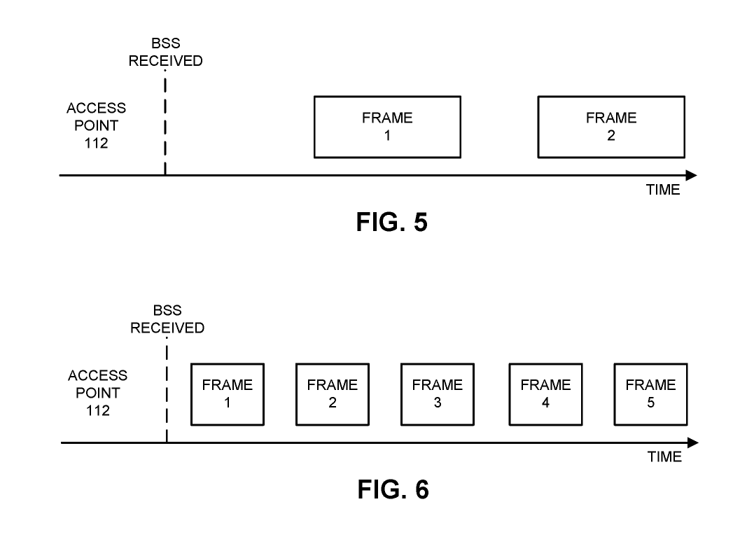

Furthermore, even when the access point receives the BSR, there is no guarantee that the access point will satisfactorily provide allocation to the electronic device. For example, the two allocations illustrated in FIGS. 5 and 6, which present flow diagrams illustrating examples of communication between electronic device 110-1 and access point 112, will deplete the buffer of electronic device 110 for a given BSR. However, these allocations result in different latency.

Thus, relative to existing scheduling approaches, there are several gaps in the capabilities in some IEEE802.11ax proposals. Notably, there is often no guaranteed manner for sending out a BSR (e.g., transmitting a BSR from electronic device 110-1 to access point 112). Moreover, QoS and persistent-traffic information is often unavailable for the resource allocation/setup device, such as the IEEE802.11ax-compatible access point 112. Furthermore, even though IEEE802.11ax has a targeted wake-up time (TWT) that can provide a persistent wake-up schedule, there usually is no guarantee that access point 112 will allocate enough resources to ensure the rate and latency of an applications associated with electronic device 110-1 within a TWT service period (SP).

In the disclosed communication technique, a scheduling-request technique is defined for an electronic device, such as electronic device 110-1. This scheduling-request technique may allow electronic device 110-1 to provide traffic QoS information to access point 112 for efficient persistent scheduling. For example, the QoS information may include one or more of: a minimum data rate, an average data rate, a maximum data rate, a minimum packet size, a nominal packet size, a maximum packet size, a packet interval/latency, and/or a time out value that indicates the interval (or duration) for which the reported QoS or the traffic information is valid.

Using the average data rate and latency, access point 112 can allocate resources to meet the basic data-rate and latency requirements of electronic device 110-1. For example, in IEEE802.11ax UL MU transmissions, access point 112 may define a transmission rate and transmission time for electronic device 110-1. Therefore, access point 112 can schedule the UL OFDMA/MU MIMO to meet the packet interval/latency of electronic device 110-1. Note that the scheduling-request technique may, e.g., be useful for isochronous traffic, such as FaceTime and Wi-Fi calling.

In some embodiments, electronic device 110-1 provides a scheduling request to access point 112 in a separate management frame. This is shown in FIG. 7, which presents a drawing illustrating an example of a management frame 700 during communication between electronic device 110-1 and access point 112. For example, a scheduling request in management frame 700 may include one or more of: a scheduling request control (SRC) 710 that indicates whether management frame 700 is for scheduling initiation, modification or deletion; a scheduling-request identifier (SR ID) 712, which is an identifier for electronic device 110-1 for the UL scheduling request; traffic data-rate information (TDRI) 714 (such as: a minimum data rate, an average data rate, a maximum data rate, a minimum packet size, a nominal packet size, a maximum packet size, and/or a nominal packet interval); a latency requirement (LR) 716 or a packet interval for the scheduling request for this stream identifier; and/or a timeout value (TV) 718 (after which, if there is no traffic to and/or from electronic device 110-1, then this scheduling request can be considered automatically deprecated). In some embodiments, management frame 700 includes one or more other MAC headers 720.

Note that it is possible that electronic device 110-1 may send a single scheduling request with combined information for multiple streams, or it may send separate scheduling requests for different traffic streams. In some embodiments, a scheduling request frame may not need a dedicated scheduling response frame. Instead, access point 112 may send an acknowledgement.

Moreover, the scheduling request control can indicate whether a frame is for scheduling initiation, modification or deletion. For example, a scheduling control field may be used to control whether the scheduling request is for initiation, modification or deletion. In some embodiments, a value of, e.g., ‘0x00’ in the scheduling request control may indicate or specify initiation, while a value of, e.g., ‘0x01’ may indicate or specify modification, and a value of, e.g., ‘0x10’ may indicate or specify deletion.

In some embodiments, a scheduling request may be conveyed in a MAC header in a frame (as opposed to using a separate management frame). This is shown in FIG. 8, which presents a drawing illustrating an example of a MAC frame header 800 during communication between electronic device 110-1 and access point 112. For example, a scheduling request may be signaled in MAC frame header, such as a HE variant HT control header. As described further below, a control identifier for a HE variant HT control header may be used.

Notably, the HE variant HT control field may include one or more fields, such as: a control identifier 810 (e.g., four bits) and/or control information 812. Note that control identifier 810 may indicate or specify a persistent traffic scheduling request and control information 812, such as a control-information subfield (which may have a variable length, e.g., up to 26 bits), may indicate or specify persistent-traffic information. Table 1 presents examples of persistent-traffic schedule requests and persistent traffic information.

TABLE 1

| | | Length of Control- | Persistent Traffic |
|---|---|---|---|
| | Persistent-Traffic Schedule- | Information Subfield | Information in Control- |
| Control ID Value | Request | (bits) | Information Subfield |
| 0 | UL MU response scheduling | 26 | UMRS control |
| | (UMRS) | | |
| 1 | Operating mode (OM) | 12 | OM control |
| 2 | HE link adaptation (HLA) | 16 | HLA control |
| 3 | Buffer status report (BSR) | 26 | BSR control |
| 4 | UL power headroom (UPH) | 8 | UPH control |
| 5 | Bandwidth query report | 10 | BQR control |
| | (BQR) | | |
| 6 | Command control indication | 8 | Command and status |
| | | | indication (CAS) |
| | | | control |
| 7-12 | Reserved | — | — |

Alternatively, the scheduling request may be conveyed or included in a data frame, such as in a MAC header. This is shown in FIG. 9, which presents a drawing illustrating an example of a frame header 900 during communication between electronic device 110-1 and access point 112. Notably frame header 900 may include a control identifier 910 (e.g., four bits) and/or control information 912 (which may have a variable length). For example, when control identifier 910 equals ‘7’, control information 912 may include one or more of: an average traffic data rate, a minimum in traffic data rate, a nominal packet size, a nominal packet interval, a latency requirement, and/or a timeout value.

Furthermore, the scheduling request may be used to indicate or specify a future or a predicted BSR. For example, instead of reporting queue sizes at a current moment in a BSR in frame header 900, in some embodiments a BSR format may be used to report one or more future (e.g., projected or estimated) queue sizes. In some embodiments, when control identifier 910 equals, e.g., ‘8’ in the scheduling request may indicate that a future or predicted BSR is being provided. In these embodiments, control information 912 in the scheduling request may include one or more of: a time interval (such as, e.g., 20, 40, 60, 80 or 100 ms), and/or one or more queue sizes predicted in this time interval. Note that such a future BSR report may be defined with a separate queue size for each traffic identifier (TID), as separate queue sizes for each access category (such as voice, video, best effort or background), a total queue size across all queues, and/or or combination of per TID, per access category and/or a total queue size.

Note that in some embodiments of management frame 700 (FIG. 7), MAC frame header 800 (FIG. 8) and/or frame header 900, the order of items can vary and additional and/or different items can be included.

In summary, in the described communication technique a scheduling request technique may allow an IEEE802.11ax-compatible electronic device (such as electronic device 110-1) to report its QoS and traffic-characteristic information to access point 112 so that access point 112 can conduct efficient scheduling. The scheduling request may contain one or more of: a scheduling-request identifier, a scheduling-request purpose (such as initiation, modification or deletion), traffic and QoS characteristics (such as a minimum data rate, an average data rate, a maximum data rate, a minimum packet size, an average packet size, a maximum packet size, a packet interval, and/or a latency requirement), and/or a timeout value (which may allow persistent scheduling to be automatically removed when there is no traffic within this timeout value). Moreover, the scheduling request can be communicated using an independent management frame or using a MAC frame header in a frame that isn't a management frame (such as a data frame). In addition, a future BSR may be reported. In these ways, the communication technique may facilitate a scheduled-based protocol for channel access and, thus, improve communication performance between one or more electronic devices (such as electronic device 110-1) and access point 112.

We now describe embodiments of an electronic device. FIG. 10 presents a block diagram of an electronic device 1000 (which may be a cellular telephone, an access point, another electronic device, etc.) in accordance with some embodiments. This electronic device includes processing subsystem 1010, memory subsystem 1012, and networking subsystem 1014. Processing subsystem 1010 includes one or more devices configured to perform computational operations. For example, processing subsystem 1010 can include one or more microprocessors, application-specific integrated circuits (ASICs), microcontrollers, graphics processing units (GPUs), programmable-logic devices, and/or one or more digital signal processors (DSPs).

Memory subsystem 1012 includes one or more devices for storing data and/or instructions for processing subsystem 1010 and networking subsystem 1014. For example, memory subsystem 1012 can include dynamic random access memory (DRAM), static random access memory (SRAM), a read-only memory (ROM), flash memory, and/or other types of memory. In some embodiments, instructions for processing subsystem 1010 in memory subsystem 1012 include: program instructions or sets of instructions (such as program instructions 1022 or operating system 1024), which may be executed by processing subsystem 1010. For example, a ROM can store programs, utilities or processes to be executed in a non-volatile manner, and DRAM can provide volatile data storage, and may store instructions related to the operation of electronic device 1000. Note that the one or more computer programs may constitute a computer-program mechanism, a computer-readable storage medium or software. Moreover, instructions in the various modules in memory subsystem 1012 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1010. In some embodiments, the one or more computer programs are distributed over a network-coupled computer system so that the one or more computer programs are stored and executed in a distributed manner.

In addition, memory subsystem 1012 can include mechanisms for controlling access to the memory. In some embodiments, memory subsystem 1012 includes a memory hierarchy that comprises one or more caches coupled to a memory in electronic device 1000. In some of these embodiments, one or more of the caches is located in processing subsystem 1010.

In some embodiments, memory subsystem 1012 is coupled to one or more high-capacity mass-storage devices (not shown). For example, memory subsystem 1012 can be coupled to a magnetic or optical drive, a solid-state drive, or another type of mass-storage device. In these embodiments, memory subsystem 1012 can be used by electronic device 1000 as fast-access storage for often-used data, while the mass-storage device is used to store less frequently used data.

Networking subsystem 1014 includes one or more devices configured to couple to and communicate on a wired and/or wireless network (i.e., to perform network operations), including: control logic 1016, an interface circuit 1018 and a set of antennas 1020 (or antenna elements) in an adaptive array that can be selectively turned on and/or off by control logic 1016 to create a variety of optional antenna patterns or ‘beam patterns.’ (While FIG. 10 includes set of antennas 1020, in some embodiments electronic device 1000 includes one or more nodes, such as nodes 1008, e.g., a pad, which can be coupled to set of antennas 1020. Thus, electronic device 1000 may or may not include set of antennas 1020.) For example, networking subsystem 1014 can include a Bluetooth™ networking system, a cellular networking system (e.g., a 3G/4G/5G network such as UMTS, LTE, etc.), a universal serial bus (USB) networking system, a networking system based on the standards described in IEEE802.11 (e.g., a Wi-Fi® networking system), an Ethernet networking system, and/or another networking system.

In some embodiments, networking subsystem 1014 includes one or more radios, such as a wake-up radio that is used to receive wake-up frames and to transition a main radio from a lower-power mode to a higher-power mode, and the main radio that is used to transmit and/or to receive frames or packets during the higher-power mode. The wake-up radio and the main radio may be implemented separately (such as using discrete components or separate integrated circuits) or in a common integrated circuit.

Networking subsystem 1014 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1000 may use the mechanisms in networking subsystem 1014 for performing simple wireless communication between the electronic devices, e.g., transmitting advertising or frame frames and/or scanning for advertising frames transmitted by other electronic devices.

Within electronic device 1000, processing subsystem 1010, memory subsystem 1012, and networking subsystem 1014 are coupled together using bus 1028 that facilitates data transfer between these components. Bus 1028 may include an electrical, optical, and/or electro-optical connection that the subsystems can use to communicate commands and data among one another. Although only one bus 1028 is shown for clarity, different embodiments can include a different number or configuration of electrical, optical, and/or electro-optical connections among the sub systems.

In some embodiments, electronic device 1000 includes a display subsystem 1026 for displaying information on a display, which may include a display driver and the display, such as a liquid-crystal display, a multi-touch touchscreen, etc. Display subsystem 1026 may be controlled by processing subsystem 1010 to display information to a user (e.g., information relating to incoming, outgoing, or an active communication session).

Electronic device 1000 can also include a user-input subsystem 1030 that allows a user of the electronic device 1000 to interact with electronic device 1000. For example, user-input subsystem 1030 can take a variety of forms, such as: a button, keypad, dial, touch screen, audio input interface, visual/image capture input interface, input in the form of sensor data, etc.

Electronic device 1000 can be (or can be included in) any electronic device with at least one network interface. For example, electronic device 1000 may include: a cellular telephone or a smartphone, a tablet computer, a laptop computer, a notebook computer, a personal or desktop computer, a netbook computer, a media player device, an electronic book device, a MiFi® device, a smartwatch, a wearable computing device, a portable computing device, a consumer-electronic device, an access point, a router, a switch, communication equipment, test equipment, as well as any other type of electronic computing device having wireless communication capability that can include communication via one or more wireless communication protocols.

Although specific components are used to describe electronic device 1000, in alternative embodiments, different components and/or subsystems may be present in electronic device 1000. For example, electronic device 1000 may include one or more additional processing subsystems, memory subsystems, networking subsystems, and/or display subsystems. Additionally, one or more of the subsystems may not be present in electronic device 1000. Moreover, in some embodiments, electronic device 1000 may include one or more additional subsystems that are not shown in FIG. 10. Also, although separate subsystems are shown in FIG. 10, in some embodiments some or all of a given subsystem or component can be integrated into one or more of the other subsystems or component(s) in electronic device 1000. For example, in some embodiments program instructions 1022 are included in operating system 1024 and/or control logic 1016 is included in interface circuit 1018.

Moreover, the circuits and components in electronic device 1000 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 1014. This integrated circuit may include hardware and/or software mechanisms that are used for transmitting wireless signals from electronic device 1000 and receiving signals at electronic device 1000 from other electronic devices. Aside from the mechanisms herein described, radios are generally known in the art and hence are not described in detail. In general, networking subsystem 1014 and/or the integrated circuit can include any number of radios. Note that the radios in multiple-radio embodiments function in a similar way to the described single-radio embodiments.

In some embodiments, networking subsystem 1014 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used a Wi-Fi communication protocol as an illustrative example, in other embodiments a wide variety of communication protocols and, more generally, wireless communication techniques may be used. Thus, the communication technique may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication technique may be implemented using program instructions 1022, operating system 1024 (such as a driver for interface circuit 1018) or in firmware in interface circuit 1018. Alternatively or additionally, at least some of the operations in the communication technique may be implemented in a physical layer, such as hardware in interface circuit 1018. In some embodiments, the communication technique is implemented, at least in part, in a MAC layer and/or in a physical layer in interface circuit 1018.

While examples of numerical values are provided in the preceding discussion, in other embodiments different numerical values are used. Consequently, the numerical values provided are not intended to be limiting.

While the preceding embodiments illustrated the use of frames or packets that are communicated using Wi-Fi, in other embodiments of the communication technique Bluetooth Low Energy is used to communicate one or more of these frames or packets. Furthermore, the frames may be communicated in the same or a different band of frequencies that the band(s) of frequencies used by the main radio. For example, at least some of the frames may be communicated in one or more bands of frequencies, including: 900 MHz, 2.4 GHz, 5 GHz, 60 GHz, and/or a band of frequencies used by LTE.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
a node configured to communicatively couple to an antenna; and
an interface circuit, communicatively coupled to the node, configured to communicate with a recipient electronic device, where the interface circuit is configured to:
receive, from the node, a frame with scheduling-request information that is associated with the recipient electronic device, wherein the scheduling-request information comprises a buffer status report for persistent traffic, and wherein the frame is compatible with an IEEE802.11 communication protocol.

2. The electronic device of claim 1, wherein the frame comprises a scheduling-request management frame.

3. The electronic device of claim 1, wherein the frame comprises a data frame and the scheduling-request information is included in a media access control (MAC) frame header.

4. The electronic device of claim 3, wherein the MAC frame header comprises a high-efficiency (HE) variant high-throughput (HT) control header.

5. The electronic device of claim 1, wherein the scheduling-request information indicates whether the scheduling request is for scheduling initiation, scheduling modification or scheduling deletion.

6. The electronic device of claim 1, wherein the scheduling-request information comprises one or more of: data-rate information, packet-size information, a packet interval, latency-requirement information, or a timeout value after which a scheduling-request is discarded.

7. The electronic device of claim 1, wherein the scheduling-request information comprises: a persistent-traffic identifier, or persistent-traffic information.

8. The electronic device of claim 1, wherein the electronic device determines a transmission schedule based at least in part on the scheduling-request information.

9. The electronic device of claim 1, wherein the electronic device provides an acknowledgement intended for the recipient electronic device in response to receiving the frame.

10. The electronic device of claim 1, wherein the electronic device comprises an access point.

11. A non-transitory computer-readable storage medium for use in conjunction with an electronic device, the computer-readable storage medium storing program instructions that, when executed by the electronic device, cause the electronic device to receive a frame by carrying out one or more operations comprising:
receiving a frame with scheduling-request information that is associated with the recipient electronic device, wherein the scheduling-request information comprises a buffer status report for persistent traffic, and wherein the frame is compatible with an IEEE802.11 communication protocol.

12. The computer-readable storage medium of claim 11, wherein the frame comprises a scheduling-request management frame.

13. The computer-readable storage medium of claim 11, wherein the frame comprises a data frame and the scheduling-request information is included in a media access control (MAC) frame header.

14. The computer-readable storage medium of claim 11, wherein the scheduling-request information indicates whether the scheduling request is for scheduling initiation, scheduling modification or scheduling deletion.

15. The computer-readable storage medium of claim 11, wherein the scheduling-request information comprises one or more of: data-rate information, packet-size information, a packet interval, latency-requirement information, or a timeout value after which a scheduling-request is discarded.

16. The computer-readable storage medium of claim 11, wherein the scheduling-request information comprises: a persistent-traffic identifier, or persistent-traffic information.

17. The computer-readable storage medium of claim 11, wherein the one or more operations comprise determining a transmission schedule based at least in part on the scheduling-request information.

18. The computer-readable storage medium of claim 11, wherein the one or more operations comprise providing an acknowledgement intended for the recipient electronic device in response to receiving the frame.

19. A method for determining a transmission schedule, comprising:
by an electronic device:
receiving a frame with scheduling-request information that is associated with the recipient electronic device, wherein the scheduling-request information comprises a buffer status report for persistent traffic, and wherein the frame is compatible with an IEEE802.11 communication protocol; and
determining a transmission schedule based at least in part on the scheduling-request information.

20. The method of claim 19, wherein the scheduling-request information indicates whether the scheduling request is for scheduling initiation, scheduling modification or scheduling deletion.
